(19) United States
(12) Patent Application Publication
(10) Pub. No.: US 2020/0410568 A1
(43) Pub. Date: Dec. 31, 2020

(54) Clothing Matching Systems and Methods

(71) Applicant: Thomas Simon, Rostraver Township, PA (US)

(72) Inventor: Thomas Simon, Rostraver Township, PA (US)

(21) Appl. No.: 16/788,473

(22) Filed: Feb. 12, 2020

Related U.S. Application Data
(60) Provisional application No. 62/867,794, filed on Jun. 27, 2019.

(51) Int. Cl. G06Q 30/06; G06T 7/90

(52) U.S. Cl. CPC G06Q 30/0631; G06T 7/90; G06Q 30/0643; G06Q 30/0629

(57) ABSTRACT

Clothing matching systems and methods for matching clothing are provided. A non-transitory, computer-readable medium comprising software instructions that, when executed by at least one processor, causes the at least one processor analyze images of articles of clothing, compare the images, and provide feedback and a recommendation on whether the articles of clothing match. A system and a method for providing clothing suggestions comprises using a mobile electronic device with a matching characteristics component to analyze images of articles of clothing, compare the images, and provide feedback and a recommendation on whether the articles of clothing match.

### CROSS-REFERENCE

This application claims priority from Provisional Patent Application Ser. No. 62/867,794 filed on Jun. 27, 2019.

### BACKGROUND

Determining if different articles of clothing match can be a difficult task for many individuals, especially those that do not often dress up or have a good sense of fashion style. People may look unprofessional at work or formal or social events if their clothing does not match. For example, attempting to match ties and dress shirts to specific color palettes and patterns can be challenging.

Clothing choices, whether found in one's own wardrobe, or when determining additional articles of clothing to purchase can confound even the most “fashion savvy” individual. We are constantly bombarded by the fashion industry, social media, and other influencers with the latest trends and styles. Outfit choices are often judged by others as to whether the wearer is stylish or not. Considering the almost infinite number of colors, styles, and pattern combinations, it is not an easy task to determine what articles of clothing go with another article of clothing.

Color matching is one of the many matching issues one must address when selecting or coordinating an outfit. Uncoordinated color combinations are one of the common outfit faux pas. Determining if two colors match may be easier when the articles of clothing are placed next to each other. However, the task becomes increasingly difficult when there are multiple pieces of clothing or clothing with multiple colors. Additionally, the task is harder when one of the articles of clothing is not physically present, such as when shopping for clothing online.

Other clothing matching issues involve leather matching, metal matching, occasion matching, and pattern matching. Patterns in particular present many of the same problems as colors. Whether certain patterns go together is not often intuitive to the casual dresser. One can quickly appreciate the difficulties of trying to match a dark blue paisley tie with a striped light blue shirt, brown checked pants, a wide black belt, and brown shoes. The combinations quickly become complicated, frequently leading to unfortunate combinations that do not match. Accordingly, there is a great need for a system or method that allows a user to determine if their clothing matches.

The present invention discloses a system, a mobile application, and a method designed to match clothing and offer outfit suggestions. Effectively, the invention allows users to maintain a sense of style when wearing shirts, ties, and other clothes by allowing the user to photograph or take a digital image of the article of clothing or outfit and analyze it to determine favorability for the article of clothing or outfit, offering improvements when needed or requested. The invention ensures that the clothing can match based on a percentage of favorability based on colors and styles, thereby potentially preventing embarrassing situations such as mismatched pants and shirts, shirts and ties, and the like.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a non-transitory computer-readable medium comprising a set of software instructions. When analyzed by at least one processor, the software instructions cause the processor to analyze an image of a first article of clothing and then an image of a second article of clothing. The processor then compares the images of both the first and second articles of clothing to a plurality of matching characteristics. Then the processor provides feedback on the plurality of matching characteristics as to whether the first article of clothing matches the second article of clothing. The processor may then provide a recommendation on whether the first article of clothing matches the second article of clothing.

The at least one processor may be a processing system of a camera-equipped mobile electronic device. The processor may additionally provide a recommendation for a plurality of additional articles of clothing that match the first article of clothing. The processor may additionally provide a recommendation for a plurality of accessories that match the first article of clothing. The plurality of matching characteristics may comprise a color palette, a pattern type, a clothing style, an occasion type, a user's hair color, or a user's skin color, or a user's skin tone.

An additional embodiment of the present invention comprises a system for providing clothing suggestions. The system comprises a camera-equipped mobile electronic device having a non-transitory computer-readable medium comprising a set of software instructions. The system further comprises a matching characteristics component. The matching characteristics component is configured to compare an image of an uploaded first article of clothing to an image of a second uploaded article of clothing for a plurality of matching characteristics. Then the matching characteristics component receives a user's input related to at least one of the plurality of matching characteristics and provides feedback on the plurality of matching characteristics. The system next provides a recommendation of whether the second article of clothing matches the first article of clothing.

An additional embodiment of the present invention comprises a method of providing clothing suggestions. The method comprises the steps of selecting an image of a first article of clothing and an image of a second article of clothing. Then a plurality of matching characteristics are provided. Next, the image of the second article of clothing is compared to the image of the first article of clothing and a recommendation is provided as to whether the first and second articles of clothing match based on the plurality of matching characteristics. The plurality of matching characteristics may comprise a color palette, a pattern type, a clothing style, an occasion type, a user's hair color, or a user's skin color, or a user's skin tone.

The method may further comprise receiving user input on the plurality of matching characteristics. The method may further comprise providing a recommendation for a plurality of additional articles of clothing that match the first article of clothing. The method may further comprise providing a recommendation for a plurality of accessories that match the first article of clothing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a schematic diagram of a computer environment for practicing aspects of the present technology in accordance with the disclosed architecture.

FIG. 2A illustrates a camera-equipped mobile electronic device displaying an image of a first article of clothing in accordance with the disclosed architecture.

FIG. 2B illustrates the camera-equipped mobile electronic device displaying an image of a second article of clothing in accordance with the disclosed architecture.

FIG. 2C illustrates the camera-equipped mobile electronic device comparing the image of a first article of clothing to the image of the second article of clothing in accordance with the disclosed architecture.

FIG. 3 illustrates a perspective view of the camera-equipped mobile electronic device displaying a plurality of matching characteristics in accordance with the disclosed architecture.

FIG. 4A illustrates the camera-equipped mobile electronic device comparing the image of a first article of clothing to the image of the second article of clothing in accordance with the disclosed architecture.

FIG. 4B illustrates the camera-equipped mobile electronic device displaying a recommendation for an additional article of clothing that matches the first and second articles of clothing in accordance with the disclosed architecture.

FIG. 4C illustrates the camera-equipped mobile electronic device displaying a recommendation for an accessory that matches the first and second articles of clothing in accordance with the disclosed architecture.

FIG. 5 illustrates the camera-equipped mobile electronic device providing a recommendation of matching of the first and second articles of clothing in accordance with the disclosed architecture.

FIG. 6 illustrates the camera-equipped mobile electronic device providing a recommendation of matching of an additional article of clothing and an accessory that matches the first and second articles of clothing in accordance with the disclosed architecture.

FIG. 7 illustrates a flowchart of a method for providing clothing suggestions in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a unique smartphone application and associated method of using the smartphone application designed to ensure that clothing matches. The application allows users to match different articles of clothing and outfits and obtain suggestions for additional clothing and accessories that match the current outfit. Users can take a self-photograph of clothing and upload the photograph into the application. Once uploaded, the application interface will tell the user whether or not the current outfit matches or is stylish. The application will offer suggestions as to what colors and items may be applied to make the outfit look better, more professional, and more fashionable. Users can then adjust their outfit accordingly.

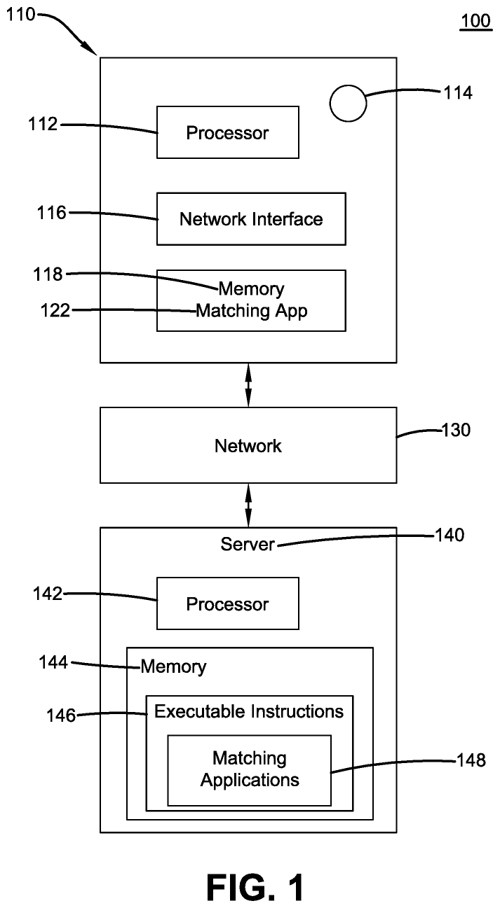

Referring initially to FIG. 1, a system 100 for providing clothing suggestions comprises a camera-equipped mobile electronic device 110. The camera-equipped mobile electronic device 110 is a user interface such as, but not limited to, a mobile phone, a smart phone, a tablet, an iPad, or the like. The camera-equipped mobile electronic device 110 is equipped with at least one processor 112, at least one camera 114 or similar image capturing device, a network interface 116, and a memory 118. The processor 112 is configured to execute instructions that are stored in the memory 118. The memory 118 comprises a non-transitory computer-readable medium comprising a set of software instructions 122 that stores a clothing matching application in the form of a matching App. The set of software instructions 122 allows the camera-equipped mobile electronic device 110 to perform methods of the present technology when executed by the at least one processor 112.

The system 100 further comprises a server 140 comprising a server processor 142 and a server memory 144. The server memory 144 comprises a set of executable software instructions 146 storing a matching characteristics component 148. A network 130 connects the camera-equipped mobile electronic device 110 to the server 140. The network 130 may be any of a number of private or public communications mechanisms such as the Internet, a local intranet, a Personal Area Network, a Local Area Network, a Wide Area Network, a Virtual Private Network, or the like. When the camera-equipped mobile electronic device 110 is connected to the server 140 via the network 130, the set of executable software instructions 146 allows the server 140 to perform methods of the present technology when executed by the server processor 142.

The matching characteristics component 148 is configured to compare an uploaded image of a first article of clothing to an uploaded image of a second article of clothing. The characteristics component 148 may additionally receive user input related to at least one of a plurality of matching characteristics and provide feedback on the plurality of matching characteristics. The system 100 may further provide a recommendation as to whether the second article of clothing matches the first article of clothing. For example, an image of a shirt may be compared to an image of a tie, and the matching application will tell the user if the tie matches the shirt.

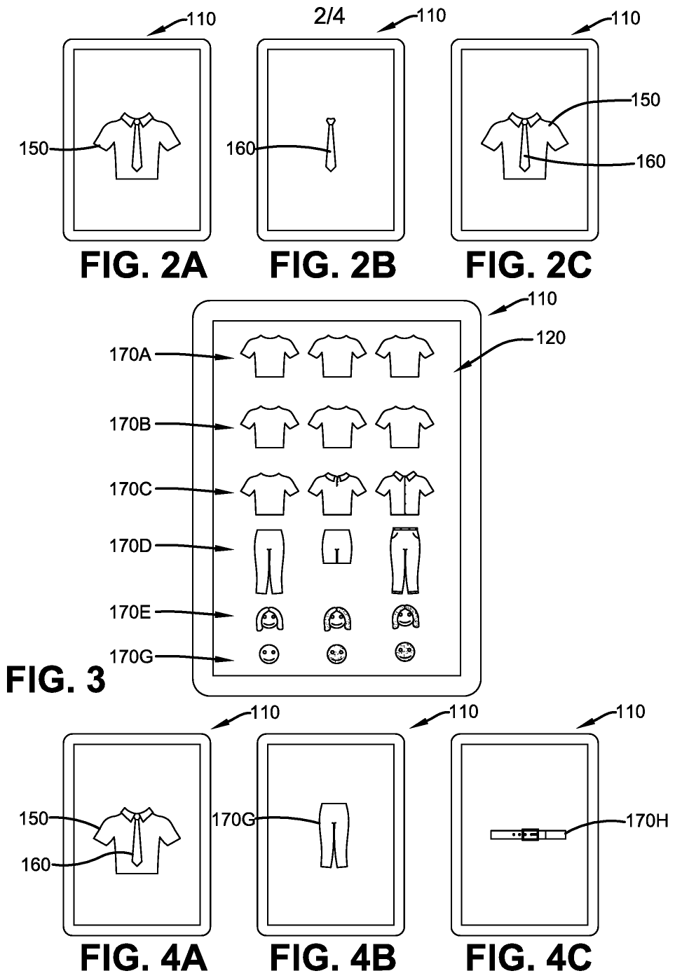

As additionally shown in FIGS. 2A-C, a non-transitory, computer-readable medium 118 comprises a set of software instructions 122, for example a matching App. The set of software instructions 122 is executable by at least one processor 112. The at least one processor 112 is a processing system of a camera-equipped mobile electronic device 110 as discussed supra. When executed by the at least one processor 112, the set of software instructions 122 will cause the at least one processor 112 to analyze an uploaded image of a first article of clothing 150 as illustrated in FIG. 2A. Next, in FIG. 2B the set of software instructions 122 will cause the at least one processor 112 to analyze an uploaded image of a second article of clothing 160. The articles of clothing may comprise any articles of clothing that may be worn together, such as, but not limited to shirts, blouses, tops, suit components, pants, skirts, dresses, shoes, hosiery, or the like.

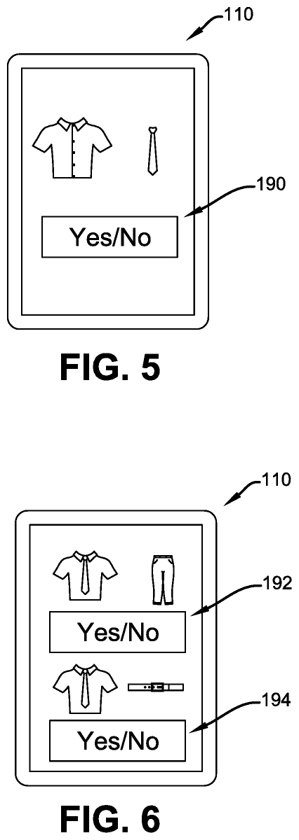

Next, the set of software instructions 122 will cause the at least one processor 112 to compare the images of the first and second articles of clothing 150 and 160 as illustrated in FIG. 2C for a plurality of matching characteristics 170 as illustrated in FIG. 3. After comparison, the set of software instructions 122 will cause the at least one processor 112 to provide feedback on the plurality of matching characteristics 170. Then, the set of software instructions 122 will cause the at least one processor 112 to provide a recommendation 190 of whether the image of the second article of clothing 160 matches the image of the first article of clothing 150 as illustrated in FIG. 5.

As illustrated in FIG. 3, the plurality of matching characteristics 170 may comprise a color palette 170A, a pattern type 170B, a clothing style 170C, an occasion type 170D, a user's hair color 170E, a user's skin tone or color 170F, or any other characteristic relevant to matching clothing. For example, if the first article of clothing 150 is a blue collared dress shirt with a herringbone pattern, and the second article of clothing 160 is a red and yellow checkered neck tie, the matching App will provide a recommendation to the user as to whether or not the combination is desirable. The color palette matching characteristic 170A may be configured to recognize matching or complimentary colors based on the color wheel, and may take into account neutral colors, shading, core color, accent colors, triad colors, analogous colors, or the like.

The pattern type matching characteristic 170B may be configured to recognize matching of complimentary patterns such as solids, strips, checks, twills, birdseye, nailshead, sharkskin, florals, paisleys, dots, or the like. The clothing type matching characteristic 170C may be configured to recognize matching of complimentary clothing types including clothing materials. The occasion type matching characteristic 170D may be configured to recognize matching of complimentary occasions with the same level of formality, such as formal, business casual, casual, sportswear, or the like. The user's hair color type matching characteristic 170E may be configured to recognize matching of complimentary hair colors with the selected articles of clothing 150 and 160. And, the user's skin color or tone type matching characteristic 170F may be configured to recognize matching of complimentary skin color or tone with the selected articles of clothing 150 and 160.

After the at least one processor 112 provides a recommendation 190 of whether the image of the second article of clothing 160 matches the image of the first article of clothing 150 as illustrated in FIG. 4A, the at least one processor 112 may then provide a recommendation 192 for a plurality of additional articles of clothing 170G that match the first article of clothing 150 as illustrated in FIGS. 4B and 6. For example, if the first article of clothing is a shirt 150 and the second article of clothing is a tie 160, the matching App may recommend a matching pair of pants, socks, shoes, etc. The matching App may employ links to online sources of clothing for sale by third parties or other advertisers.

After the at least one processor 112 provides a recommendation 190 of whether the image of the second article of clothing 160 matches the image of the first article of clothing 150 as illustrated in FIG. 4A, the at least one processor 112 may then provide a recommendation 194 for a plurality of accessories that match the first article of clothing 150 as illustrated in FIGS. 4C and 6. For example, if the first article of clothing is a shirt 150 and the second article of clothing is a tie 160, the App may recommend matching jewelry, belts, pocket squares, watches, etc. The matching App may employ links to online sources of accessories for sale by third parties or other advertisers.

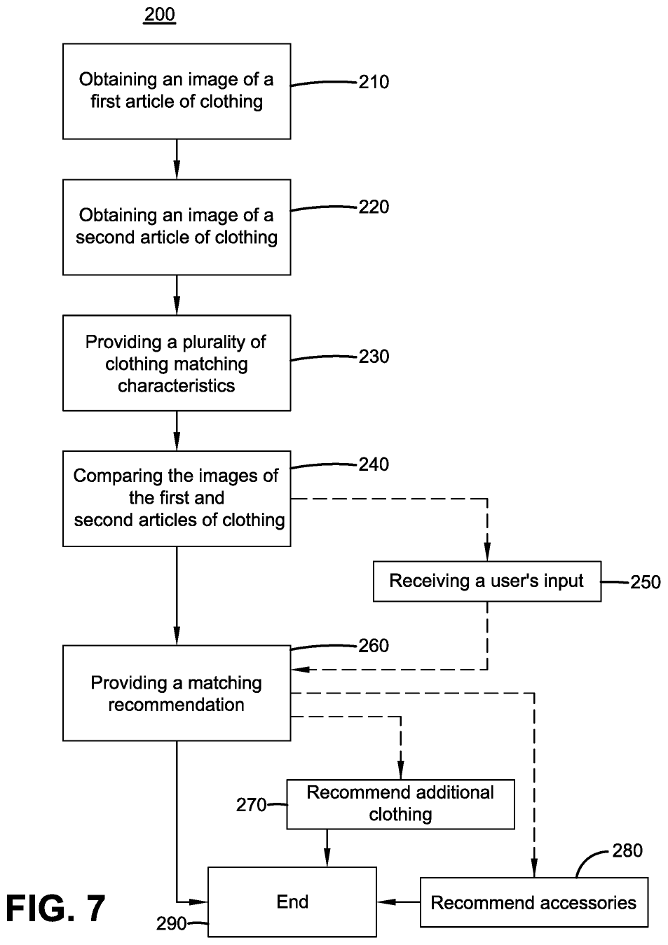

FIG. 7 is a flowchart of an exemplary method 200 of providing clothing recommendations executable using the system 100 of the camera-equipped mobile electronic device 110 or the server 140 as described supra. The method 200 comprises obtaining an image of a first article of clothing 160 using the camera-equipped mobile electronic device 110 at 210. At 220, an image of a second article of clothing 160 is obtained using the camera-equipped mobile electronic device 110. Next, a plurality of matching characteristics 170 is provided via a matching application 148 at 230.

A set of software instructions 122 compares the image of the second article of clothing 160 to the image of the first article of clothing 150 at 240. At this point, the user may provide input or feedback related to the articles of clothing 150 and 160, or other user preferences using the camera-equipped mobile electronic device 110 at 250. Then the matching application 148 provides a recommendation 190 as to whether the images of the first and second articles of clothing 150 and 160 match based on the plurality of matching characteristics 170 at 260.

As before, the plurality of matching characteristics 170 may comprise a color palette 170A, a pattern type 170B, a clothing style 170C, an occasion type 170D, a user's hair color 170E, a user's skin tone or color 170F, or any other characteristic relevant to matching clothing. At 270, the method may further comprise providing a recommendation 192 for a plurality of additional articles of clothing (for example 170G) that match the image of the first or second articles of clothing 150 and 160. At 280, the method may further comprise providing a recommendation 192 for a plurality of accessories (for example 17011) that match the image of the first or second articles of clothing 150 and 160. The method then ends at 290.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-transitory, computer-readable medium comprising software instructions that, when executed by at least one processor, causes the at least one processor to:
analyze an image of a first article of clothing;
analyze an image of a second article of clothing;
compare the images of the first and second articles of clothing for a plurality of matching characteristics; and
provide feedback on the plurality of matching characteristics.

2. The non-transitory, computer-readable medium according to claim 1, wherein the at least one processor provides a recommendation of whether the second article of clothing matches the first article of clothing.

3. The non-transitory, computer-readable medium according to claim 1, wherein one of the plurality of matching characteristics is a color palette.

4. The non-transitory, computer-readable medium according to claim 1, wherein one of the plurality of matching characteristics is a pattern type.

5. The non-transitory, computer-readable medium according to claim 1, wherein one of the plurality of matching characteristics is a clothing style.

6. The non-transitory, computer-readable medium according to claim 1, wherein one of the plurality of matching characteristics is an occasion type.

7. The non-transitory, computer-readable medium according to claim 1, wherein one of the plurality of matching characteristics is a user's hair color.

8. The non-transitory, computer-readable medium according to claim 1, wherein one of the plurality of matching characteristics is a user's skin tone.

9. The non-transitory, computer-readable medium according to claim 1, wherein the at least one processor is a processing system of a camera-equipped mobile electronic device.

10. The non-transitory, computer-readable medium according to claim 1, wherein the at least one processor provides a recommendation for a plurality of additional articles of clothing that match the first article of clothing.

11. The non-transitory, computer-readable medium according to claim 1, wherein the at least one processor provides a recommendation for a plurality of accessories that match the first article of clothing.

12. A system for providing clothing suggestions, comprising:
a camera-equipped mobile electronic device having a non-transitory, computer-readable medium comprising software instructions; and
a matching characteristics component configured to:
compare an image of an uploaded first article of clothing to an image of a second uploaded article of clothing for a plurality of matching characteristics;
receive user input related to at least one of the plurality of matching characteristics; and
provide feedback on the plurality of matching characteristics.

13. The system according to claim 12 further comprising providing a recommendation of whether the second article of clothing matches the first article of clothing.

14. A method of providing clothing suggestions comprising the steps of:
obtaining an image of a first article of clothing;
obtaining an image a second article of clothing;
providing a plurality of clothing matching characteristics;
comparing the image of the second article of clothing to the image of the first article of clothing; and
providing a recommendation as to whether the images of the first and second articles of clothing match based on the plurality of clothing matching characteristics.

15. The method of claim 14 further comprising receiving user input on the plurality of clothing matching characteristics.

16. The method of claim 14, wherein one of the plurality of clothing matching characteristics is a color palette.

17. The method of claim 14, wherein one of the plurality of clothing matching characteristics is a pattern type.

18. The method of claim 14, wherein one of the plurality of clothing matching characteristics is a clothing type.

19. The method of claim 14 further comprising providing a recommendation for a plurality of additional articles of clothing that match the image of the first article of clothing.

20. The method of claim 14, further comprising providing a recommendation for a plurality of accessories that match the image of the first article of clothing.
